(19) United States
(12) Patent Application Publication
(10) Pub. No.: US 2004/0200059 A1
(43) Pub. Date: Oct. 14, 2004

(54) Automated production system for wiring harness and terminal crimping apparatus

(75) Inventor: Hideyuki Ema, Yokkaichi-shi (JP)

Correspondence Address: CASELLA & HESPOS, 274 MADISON AVENUE, NEW YORK, NY, 10016

(73) Assignee: Sumitomo Wiring Systems, Ltd., Yokkaichi-shi (JP)

(21) Appl. No.: 10/820,314

(22) Filed: Apr. 8, 2004

(30) Foreign Application Priority Data
Apr. 10, 2003 (JP) 2003-106938

(51) Int. Cl. B23P 19/00

(52) U.S. Cl. 29/742; 29/748; 29/751; 29/753; 29/868

(57) ABSTRACT

In order to maximally reduce a space necessary for a terminal crimping apparatus to improve operability and maintenance readiness, terminal reels 422 and applicators 421 are arranged in such inclined states that terminals can be fed in a direction oblique to a wire conveyance path PH. A wire is fed to the applicators 421 by wire clamping units. Each wire clamping unit is so constructed as to switch the position thereof between a pressing position in which the end of the wire can be connected with a terminal and a normal position in which the end of the wire can be transferred to and from the remaining units.

### BACKGROUND OF THE INVENTION

1. Field of the Invention

The present invention relates to an automated production system for wiring harness and a terminal crimping apparatus.

2. Description of the Background Art

Generally upon producing a wiring harness, insulation wires are cut to measured lengths, a terminal is connected with at least one end of each cut wire, and the connected terminal is inserted into a connector housing to connect the wire with a connector. A method for automating these operation steps is such that the cut wire is let to suspend while being clamped near the opposite ends thereof by means of a pair of wire clamps, the respective wire clamps are sequentially driven along a straight wire conveyance path to supply the ends of the wire to units arranged along the wire conveyance path for stripping, terminal connection and other processing.

In above processes, a terminal crimping apparatus is widely used upon connecting the terminal with the ends of the cut wires. The terminal crimping apparatus is a unit including an applicator for crimping the terminal and a pressing machine for driving the applicator. Terminal belt in which terminals are successively connected is fed to the applicator. Applicator cuts the terminal belt to have an individual terminal which is then connected with end of the wire. There has been also developed a terminal crimping apparatus of the type in which a plurality of applicators is driven by one pressing machine (see Japanese Unexamined Patent Publication No. 2001-52834). Generally, the terminal belt has been arranged behind the pressing machine (at the side opposite from the wire conveyance path) in the terminal crimping apparatus and fed to the applicator while being twisted in a direction intersecting with the wire conveyance path with the trailing end thereof aligned with the wire conveyance path. There has been also developed a terminal crimping apparatus of the type in which two torque transmitting units are coupled to one servo motor and applicators provided for the respective torque transmitting units are selectively driven (see Japanese Unexamined Patent Publication No. 2002-158076).

There has been a demand to install a relatively large number of (e.g. eight) terminal crimping apparatuses in one production line since the number of circuits and the number of kinds of circuits of wiring harnesses to be produced have been increased in recent years. On the other hand, it is also necessary to efficiently exchange the installed terminal crimping apparatuses in order to deal with a small-lot-sized or jobbing production. However, the conventional terminal crimping apparatuses have a problem that a large space is taken up for supplying the terminals to the applicator to uselessly lengthen movement paths of an operator. Particularly, in the case of adopting the terminal crimping apparatus of Japanese Unexamined Patent Publication No. 2001-52834, a plurality of applicators have to be arranged along a wire conveying direction. Thus, the terminals is fed in direction parallel with the wire conveying direction at a downstream side, which necessitates a large space along the wire conveying direction. If this space is excessively reduced, a conveyance path of the terminal belt from a terminal reel to the applicator is largely twisted, thereby hindering a smooth supply of the terminals. Therefore, the automated wiring harness production of recent years has had a problem of a larger space necessary for the terminal crimping apparatuses and a problem of reduced operability and maintenance readiness.

### SUMMARY OF THE INVENTION

In view of the problems residing in the prior art, an object of the present invention is to provide an automated production system for wiring harness and a terminal crimping apparatus which have high operability and maintenance readiness by maximally reducing a space necessary for the terminal crimping apparatus.

One aspect of the present invention is directed to an automated production system for wiring harness in which a terminal reel and an applicator are arranged in such oblique position that terminals can be fed in a direction oblique to a wire conveyance path. Another aspect of the present invention is directed to an automated production system for wiring harness comprising a switching unit for individually switching the positions of wire clamps between a pressing position in which the end of the wire are fed to the applicator to be connected with the terminal and a normal position in which the end of the wire is transferred to and from the remaining apparatuses.

Another aspect of the present invention is directed to a terminal crimping apparatus in which a terminal reel and an applicator are arranged in such inclined states that terminals be fed in a direction oblique to a wire conveyance path. According to this aspect, intervals between applicators along the wire conveyance paths can be maximally narrowed. Thus, a movement path of an operator between the respective applicators can be shortened.

These and other objects, features and advantages of the present invention will become more apparent upon a reading of the following detailed description and accompanying drawings.

### BRIEF DESCRIPTION OF THE DRAWINGS

FIG. 1 is a schematic plan view showing an automated production system for wiring harness according to one embodiment of the invention,

FIG. 2 is a perspective view schematically showing an essential portion of a wire conveyor,

FIG. 3 is a side view of a wire clamping unit,

FIGS. 4 and 5 are schematic plan views of the wire clamping unit,

FIG. 6 is a schematic diagram showing a simplified construction of a facility installed at a wire measuring/cutting station,

FIG. 7 is a front view of a terminal crimping apparatus according to one embodiment of the invention,

FIG. 8 is a side view of the terminal crimping apparatus,

FIGS. 9 and 10 are schematic plan views showing operations at the wire measuring/cutting station according to the embodiment,

FIG. 11 is a schematic plan view showing operations at the wire measuring/cutting station according to the embodiment,

FIG. 12 is a schematic plan view showing operations at the wire measuring/cutting station and an end processing station according to the embodiment,

FIG. 13 is a schematic plan view showing an operation at the end processing station according to the embodiment,

FIGS. 14 to 16 are schematic plan views showing an operation at a terminal connecting station according to the embodiment,

FIG. 17 is a schematic plan view showing an operational a inspection station according to the embodiment, and

FIG. 18 is a schematic plan view showing an operation at a transferring station according to the embodiment.

### DESCRIPTION OF THE PREFERRED EMBODIMENTS

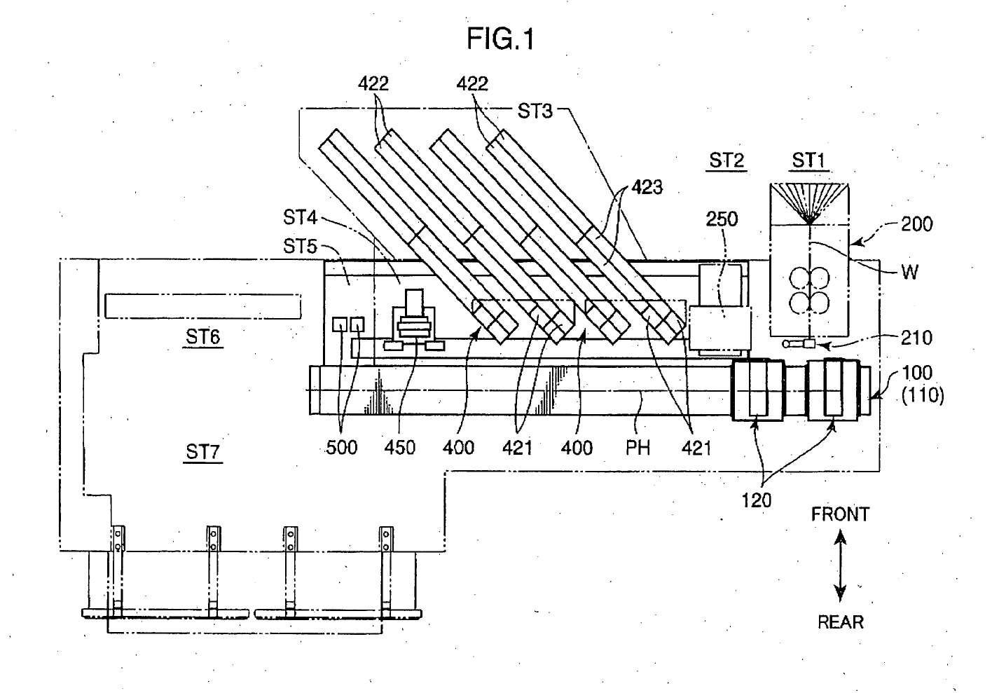

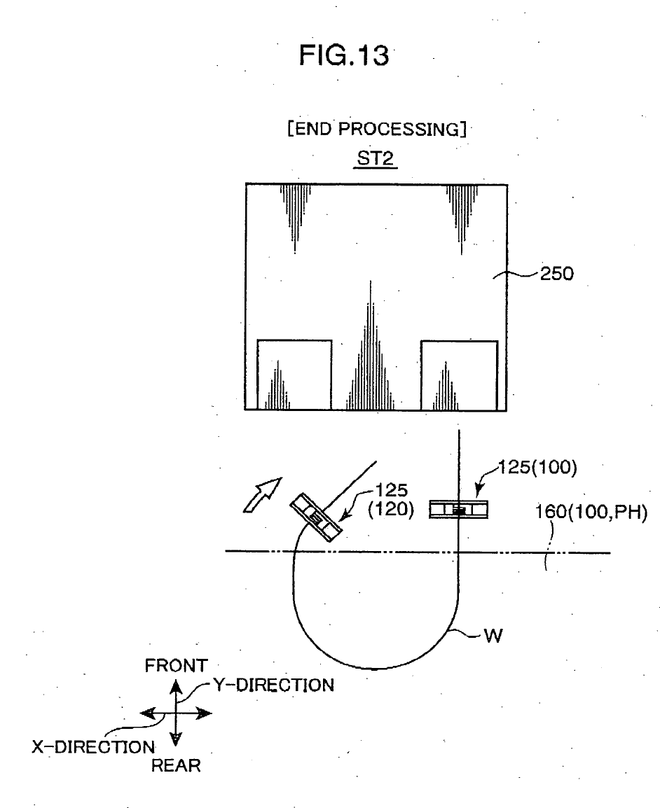

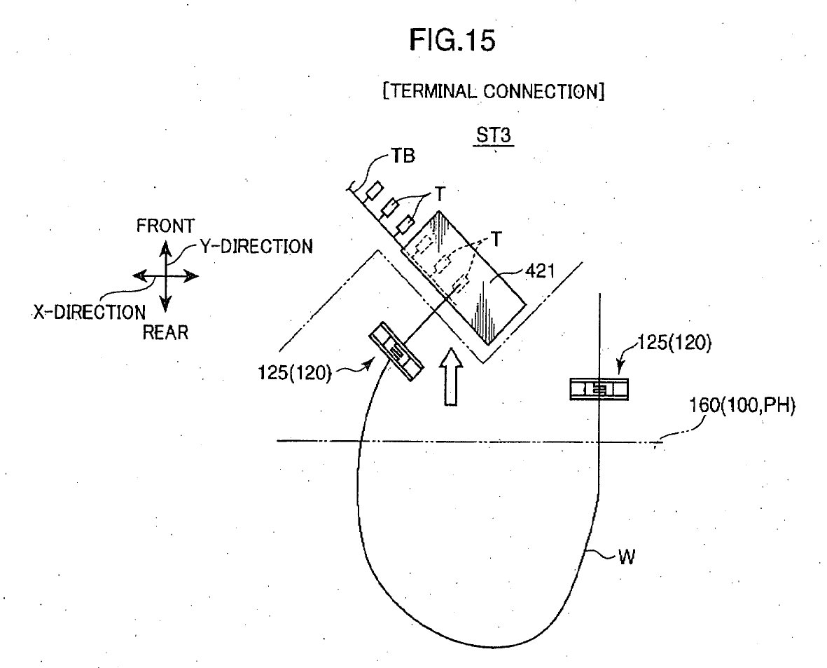

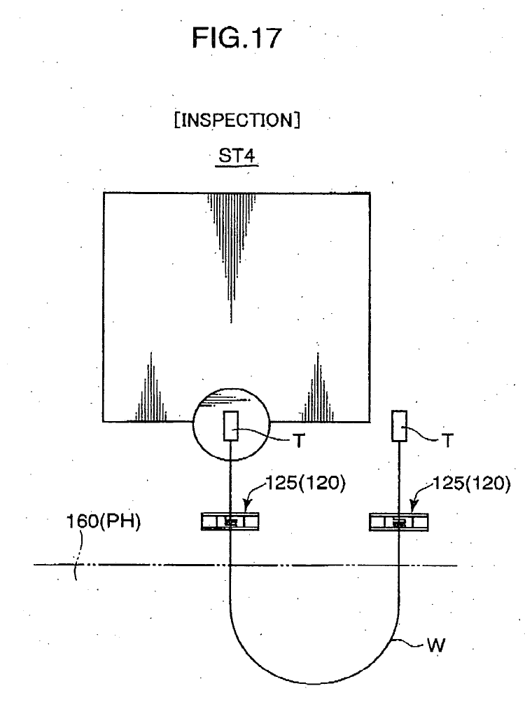

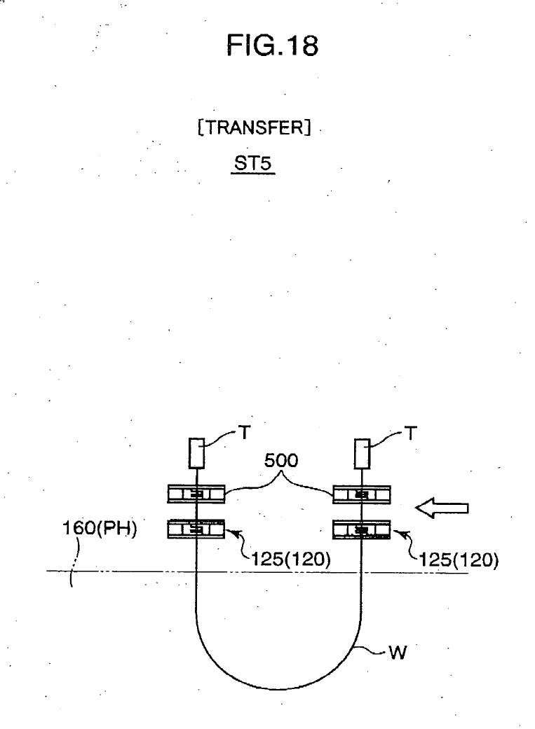

With reference to FIG. 1, there are, in this embodiment, provided a wire measuring/cutting station ST1 where an insulation wire W is dispensed from an unillustrated roll and cut to a specified measured length an end processing station ST2 where ends of the cut wire W are processed; a terminal connecting station ST3 where terminals T are connected with the processed ends of the wire W (see FIGS. 13 to 16); a inspection station ST4 where the connected terminals T are inspected (see FIG. 17); a transferring station ST5 where the terminals T of the wire W having succeeded in the inspection (see FIG. 18) are transferred; a terminal inserting station ST6 where the terminal-crimped wire is received from the transferring station ST5 and the terminal is inserted into a connector housing (not shown); and a product unloading station ST7 where an assembly of the wires as a wiring harness in which the terminals T are inserted into the connectors is unloaded.

The wire measuring/cutting station ST1 is provided with a measuring unit for measuring the wire W to a predetermined length and a cutting unit for cutting the ends of the measured wire section at right angles. In order to convey the wire W cut to the specified length at this wire measuring/cutting station ST to the stations at a downstream side, a wire conveyor 100 is installed from the wire measuring/cutting station ST1 to the transferring station ST5.

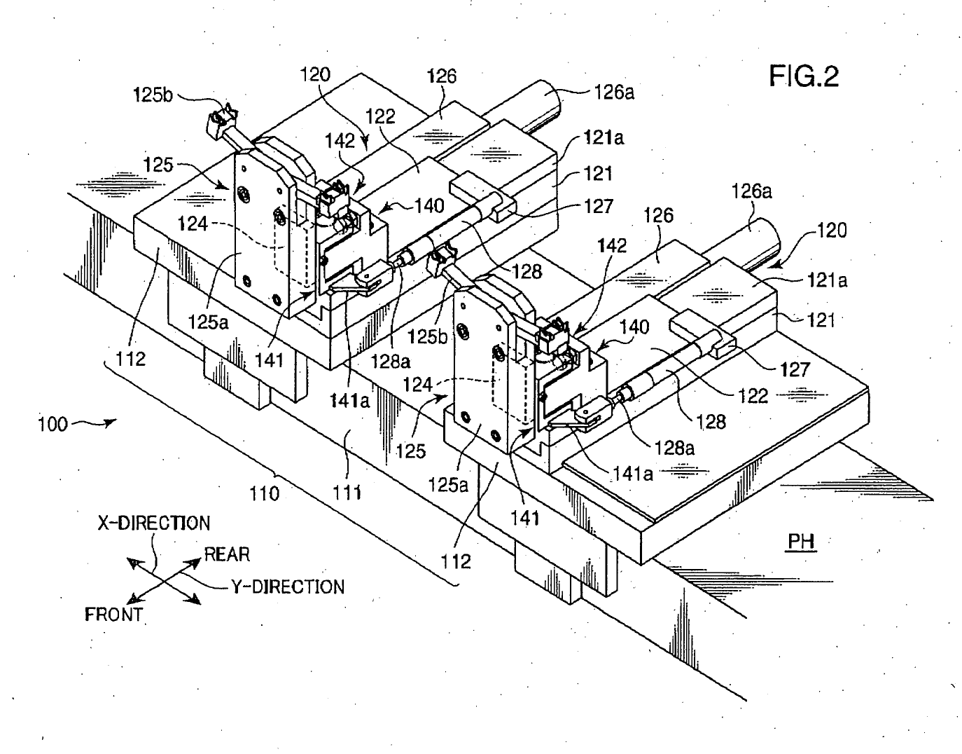

With reference to FIG. 2, the wire conveyor 100 according to this embodiment constructs a wire conveyance path PH extending in a direction along which the respective stations ST1 to ST5 are arranged side by side by an unillustrated controlling mechanism. The wire conveyor 100 includes a linear unit 110 for constructing the wire conveyance path PH along which the wire W is conveyed from the wire measuring/cutting station ST1 to the transferring station ST5, and a pair of wire clamping units 120 sequentially conveyed by the linear unit 110.

The linear unit 110 includes a linear conveyor 111 for constructing the wire conveyance path PH, a pair of linear tables 112 which are reciprocally moved along the wire conveyance path PH by the linear conveyor 111, and linear motors (not shown) provided in the respective linear tables 112. The linear tables 112 are individually and reciprocally moved by the unillustrated linear motors. In the following description, a direction along which the linear tables 112 are reciprocally moved is referred to as an X-direction and a direction normal to the X-direction is referred to as a Y-direction.

With reference also to FIGS. 1 to 5, each of the wire clamping units 120 is provided with an LM guide 121 fixed onto the corresponding linear table 112, a slider 121a provided on the LM guide 121 and reciprocally movable along the Y-direction, a table 122 fixed onto the slider 121a, a pivoting unit 140 provided at an end of the table 122 along the Y-direction at a side (hereinafter, this side is referred to as front side) where the respective stations ST1 to ST5 are set, a linear actuator 124 mounted at the front end of the pivoting unit 140, and a wire clamp 125 elevatably carried by the linear actuator 124.

A one-axis robot 126 having a servo motor 126a is provided at one side of the LM guide 121 for driving the table 122 forward and backward.

An air cylinder 128 is coupled to the table 122 via a stay 127. The air cylinder 128 is arranged along the Y-direction and a rod 128a thereof is faced forward. An end of the rod 128a is coupled to a stay 141a of the pivotal member 141 provided in the pivoting unit 140.

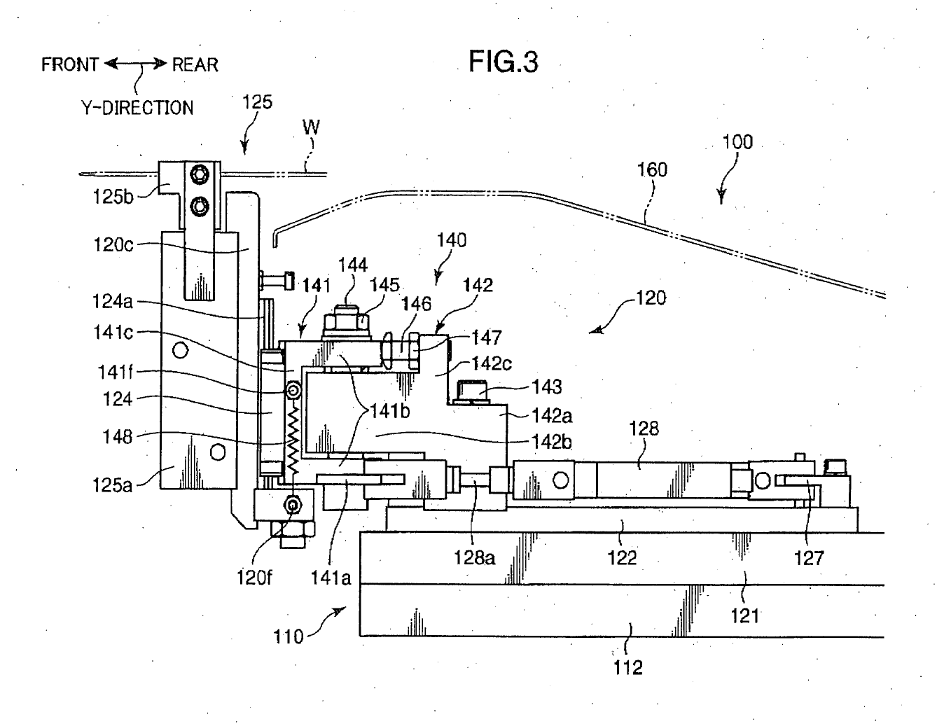

As shown in FIG. 3, the pivoting unit 140 includes the pivotal member 141 and a block 142 fixed to the table 122 for supporting this pivotal member 141. The pivotal member 141 is a structural element having a substantially U-shaped side view by connecting the opposite ends of an end wall portion 141c with a pair of upper and lower plate portions 141b at right angles, and is arranged in such a position where the recess thereof is faced backward and the free ends thereof are vertically opposed to each other. The stay 141a coupled to the air cylinder 128 is so welded as to project sideways from the lower plate portion 141b.

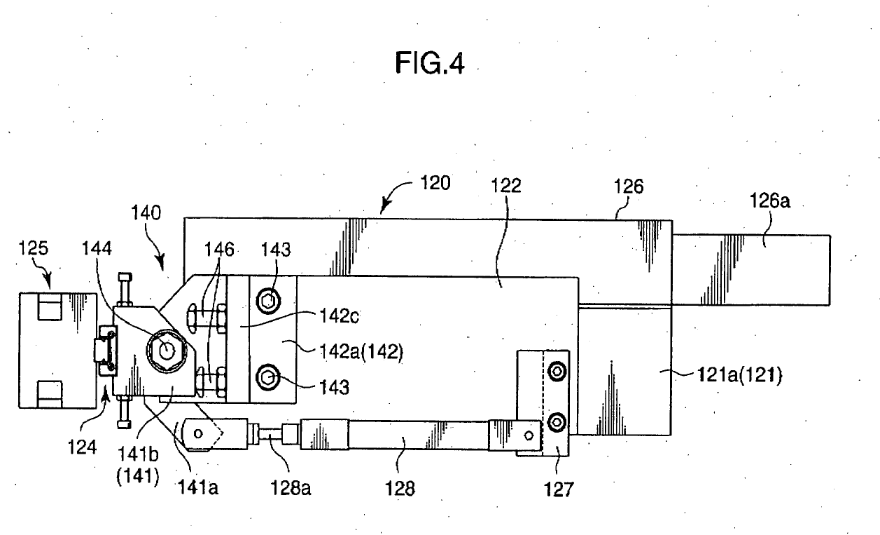

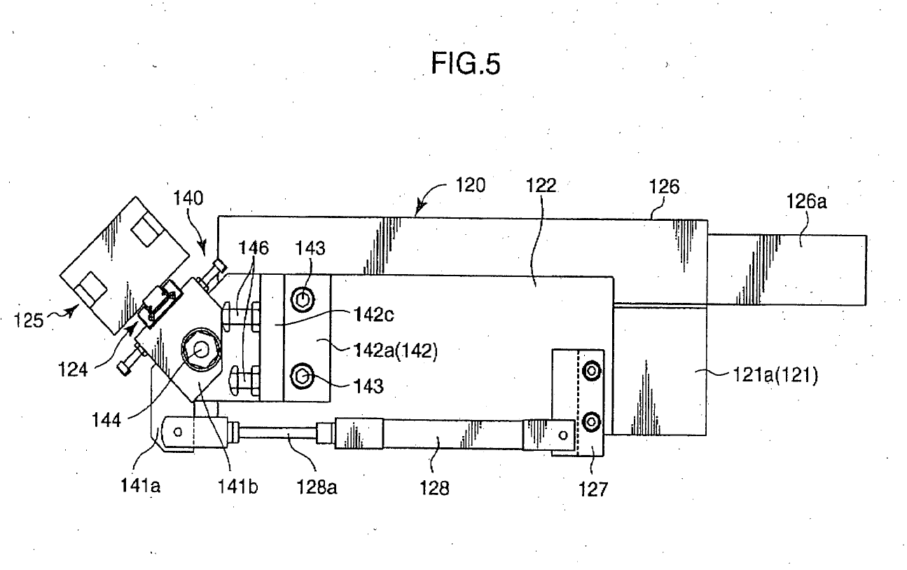

The block 142 is a metallic member integrally formed with a base portion 142a substantially in the form of a rectangular parallelepiped secured to the table 122 by a bolt 143, a supporting block portion 142b projecting forward from this base portion 142a, and a wall portion 142c projecting from an upper rear end of the supporting block portion 142b. The supporting block portion 142b has parameters thereof so set as to be insertable between the plate portions 141b of the pivotal member 141, and supports the pivotal member 141 about a vertical axis by a bolt extending along the vertical axis, a nut 145 screwed onto the bolt 144 and an unillustrated built-in bearing for rotatably bearing the bolt 144. A pair of bolts 146 are so mounted on the wall portion 142c as to extend in forward and backward directions, and are fixed such that a projecting distance thereof is adjustable by nuts 147. The respective bolts 146 are opposed to the rear end of the plate portion 141b of the pivotal member 141 coupled to the supporting block portion 142b. On the other hand, as shown in FIGS. 4 and 5, the upper plate portion 141b of the pivotal member 141 has one corner thereof cut off. By the shape of the cut-off corner of the upper plate portion 141b and the adjustment of the projecting distance of the respective bolts 146, the pivotal member 141 has its pivotal range specified between a normal position where the wire clamp 125 faces in horizontal direction normal to the wire conveyance path PH as shown in FIG. 4 and a pressing position where the wire clamp 125 is turned by. 45° in clockwise direction with respect to the wire conveyance path PH as shown in FIG. 5.

Each wire clamp 125 is a known unit including a casing 125a and a pair of clamp arms 125b provided at the top of the casing 125a, and has the respective clamp arms 125b symmetrically turned by an unillustrated actuator built in the casing 125a, thereby being enabled to take a wire releasing position where both clamp arms 125b are laid substantially in horizontal direction as shown in FIG. 2 and a wire clamping position where both clamp arms 125b vertically stand to clamp the wire W as shown in FIG. 2.

With reference to FIG. 3, in order to couple the wire clamp 125 and the pivotal member 141 of the pivoting unit 140, the linear actuator 124 is fixed to the end wall portion 141c of the pivotal member 141 and the LM guide 124a is fixed to the rear surface of the casing 125a of the wire clamp 125 via a mounting plate 120c. This linear actuator 124 elevatably bears the wire clamp 125. Further, in the shown embodiment, a bolt 141f projects at each side of the end wall portion 141c, and coupling bolts 120f arranged below the respective bolts 141f and facing them in parallel are provided at a bottom part of the mounting plate 120c. A tensile coil spring 148 is disposed between a corresponding pair of the bolts 141f, 120f to bias the wire clamp 125. As a result, the wire claim 125 is made resiliently movably upward and downward during a pressing operation to be described later in addition to being made movable upward and downward by the linear actuator 124.

A cover 160 is provided over a range within which the wire clamping unit 120 is reciprocally movable along the X-direction, whereby the wire clamping unit 120 is covered while having-only the wire clamps 125 exposed to the outside.

By taking the above construction, the wire conveyor 100 can convey the wire w cut to the specified measured length at the wire measuring/cutting station ST1 from the station ST1 to the stations ST2, ST3, . . . ST5 at the downstream side along the wire conveyance path PH while holding it.

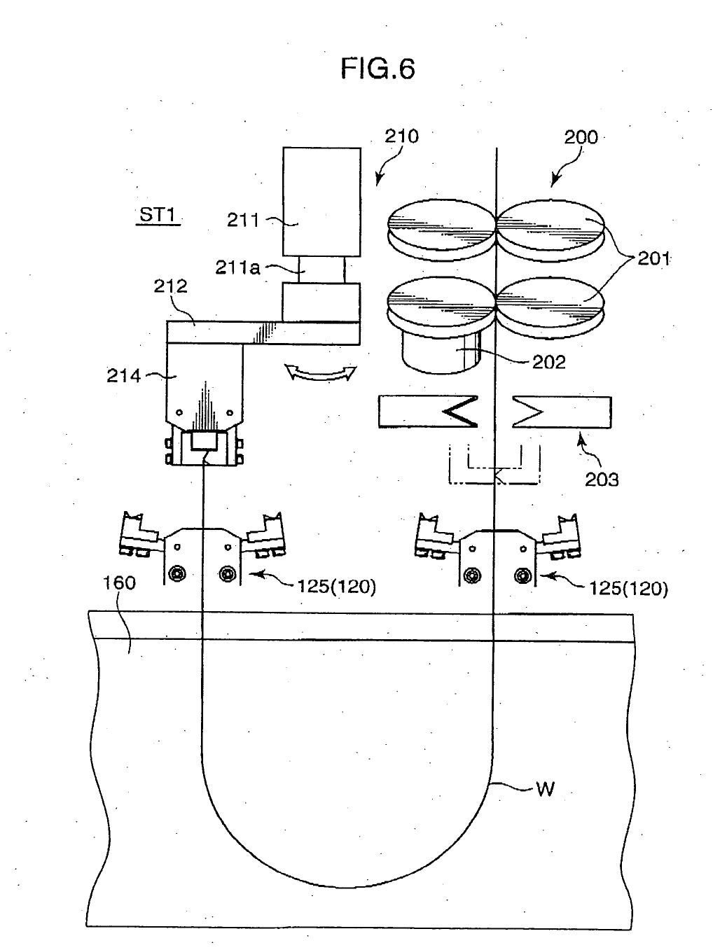

FIG. 6 is a schematic diagram showing a simplified construction of a facility installed at the wire measuring/cutting station ST1.

With reference to FIG. 6, the wire measuring/cutting station ST1 is provided with a known wire measuring/cutting apparatus 200 and a known wire dispensing apparatus 210. The wire measuring/cutting apparatus 200 includes a roller unit 201 for dispensing the selected wire W, a rotary encoder 202 included in the roller unit 201, a cutting unit 203 for cutting the wire W to a specified length measured by the rotary encoder 202. The wire dispensing apparatus 210 is adapted to transfer the wire W dispensed by the wire measuring/cutting apparatus 200 to the wire clamps 125 of the wire conveyor 100, and includes a servo motor 211 for rotating an output shaft 211a about a vertical axis, a rotary arm 212 rotated about the vertical axis by the output shaft 211a of the servo motor 211, and a wire clamp 214 provided at a free end of the rotary arm 212. The wire clamp 214 holds the wire w at a dispensing position shown by phantom line in FIG. 6, the rotary arm 212 is turned by 180° to move the wire clamp 214 to a dispensing position shown in solid line in FIG. 6, whereby the wire W can be dispensed in a looped manner on the cover 160. Thus, the pair of wire clamping units 120 juxtaposed on the wire conveyor 100 can receive near ends portions of the looped wire W cut to the specified length

With reference to FIG. 1, a stripping unit 250 for stripping the insulation coating at the aligned ends of the wire W and a sensor unit (not shown) for sensing the stripped ends of the wire W are arranged at the end processing station ST2. Whether or not the stripped state of the wire W (length of the exposed core and loosening of strands) is satisfactory is inspected by sensing the end portions of the wire W by means of this sensor unit.

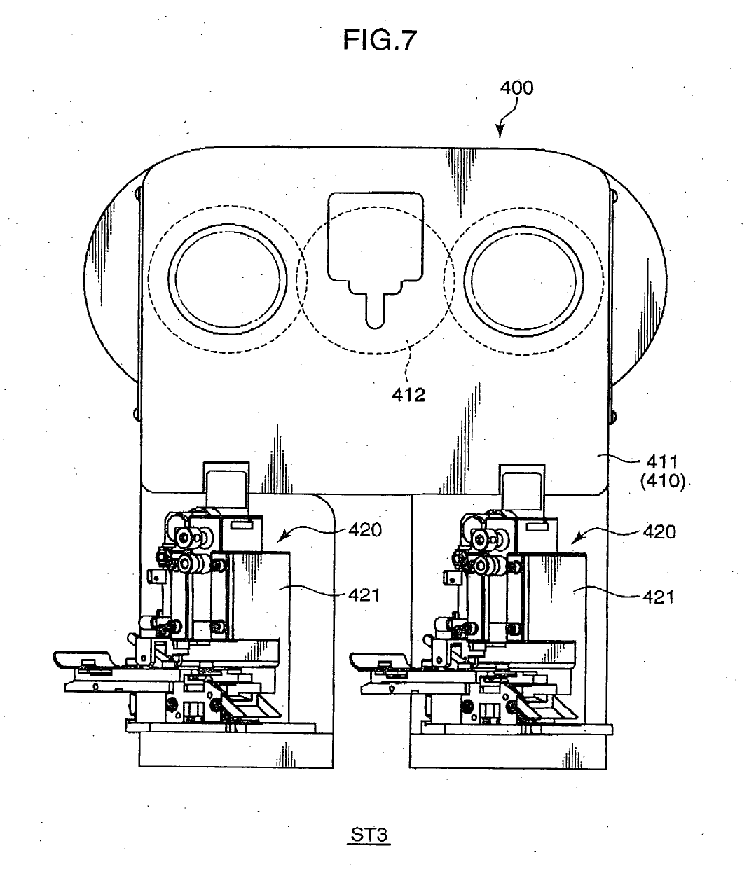

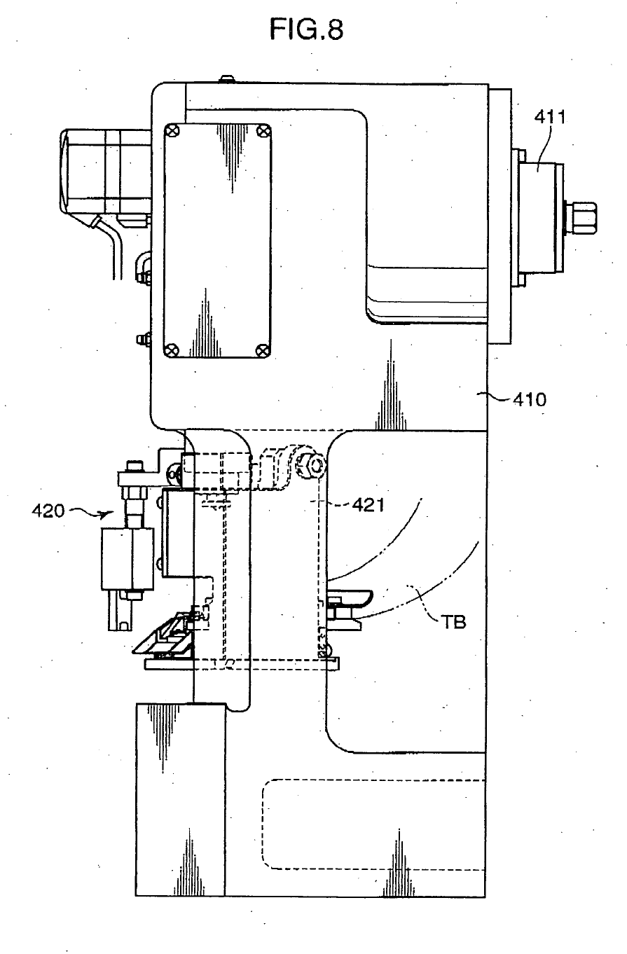

Next, the terminal connecting station ST3 is described in detail with reference to FIGS. 7 and 8.

FIG. 7 is a front view of a terminal crimping apparatus 400 according to this embodiment, and FIG. 8 is a side view of this terminal crimping apparatus 400.

With reference to FIGS. 7 and 8, a plurality of kinds of terminal crimping apparatuses 400 corresponding to the specifications of the wires W to be processed along the wire conveyance path PH specified by the wire conveyor 100 are arranged at the terminal connecting station ST3.

Each terminal crimping apparatus 400 is provided with a main body 410 facing an intermediate portion of the wire conveyance path PH and a pair of applicator units 420 mounted in a pair on the main body 410.

The main body 410 includes one pressing machine 411 and a pair of power transmitting mechanisms 412 for transmitting a torque of this pressing machine 411.

The pressing machine 411 is realized by a servo motor and is caused to output a torque at a timing determined beforehand in synchronization with the conveyance of the wire W by the control of an unillustrated microprocessor.

Each power transmitting mechanism 412 selectively transmits the torque outputted from the pressing machine 411 to the respective applicator units 420 while transforming it into a vertical motion. Since how the power transmitting mechanism transmits the torque into the vertical motion and selectively transforms the vertical motion to the two applicator units 420 are disclosed in the aforementioned Japanese Unexamined Patent. Publication No. 2002-158076, no detailed description is given here.

Each applicator unit 420 is an assembly unit of an applicator 421 for crimping the terminal, a terminal reel (only schematically shown in FIG. 1) 422 for supplying a terminal belt TB to the applicator 421 and a frame 423 (only schematically shown in FIG. 1) integrally carrying the terminal reel 422 and the applicator 421. The applicator 421 mounted in the frame 423 can be detachably coupled to the power transmitting mechanism 412 by mounting this frame 423 on the main body 410. Since a construction in which the applicator and the terminal reel are assembled into an integral unit by the frame and detachably attachable to the pressing machine is disclosed, for example, in Japanese Unexamined Patent Publication No. 2000-140960, no detailed description is given here.

In this embodiment, as shown in FIG. 1, attaching and detaching directions of the frame 423 to and from the main body 410 are set to be oblique to the wire conveyance path PH; the applicators 421 are at 45° to the wire conveyance path PH in clockwise direction; and the terminal reels 422 are so arranged as to supply a terminal belt TB (see FIGS. 8 and 13 to 16) in a straight state to the applicators 421 in plan view. As a result, intervals between the respective applicators 421 with respect to the direction of the wire conveyance path PH can be considerably shortened.

An inspecting apparatus 450 for inspecting the terminals crimped into connection with the wire ends by the applicator 421 is arranged at the inspection station ST4. This inspecting apparatus 450 can inspect the connected states of the respective terminals by means Of an image. A height measuring apparatus is also arranged at this inspection station ST4 for inspecting whether or not the height of a crimped wire barrel (not shown) of the terminal T is satisfactory.

A transferring unit 500 and a reversing unit (not shown) are arranged together with the transferring station ST5. The wire W conveyed to the downstream end of the wire conveyor 100 is received by the transferring unit 500, and the reversing unit turns predetermined terminal T with respect to the wire W about longitudinal axis by 180°.

A known connector housing supplying apparatus and a wire connecting apparatus (not shown) are arranged side by side at the terminal inserting station ST6. The wires W having the terminals crimped into connection with the ends thereof are inserted into a connector housing by these apparatuses, thereby constructing a wire-connector assembly.

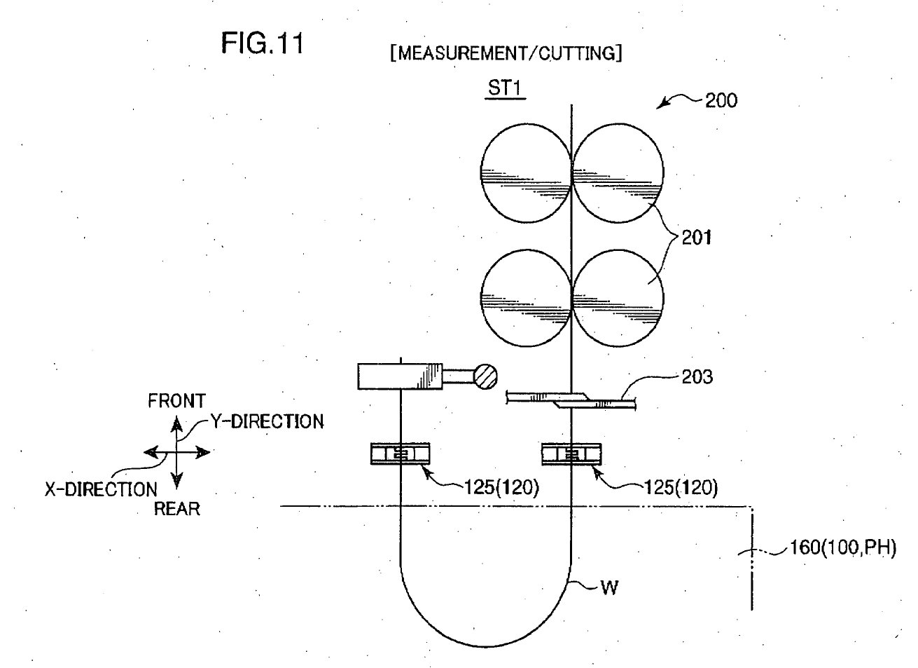

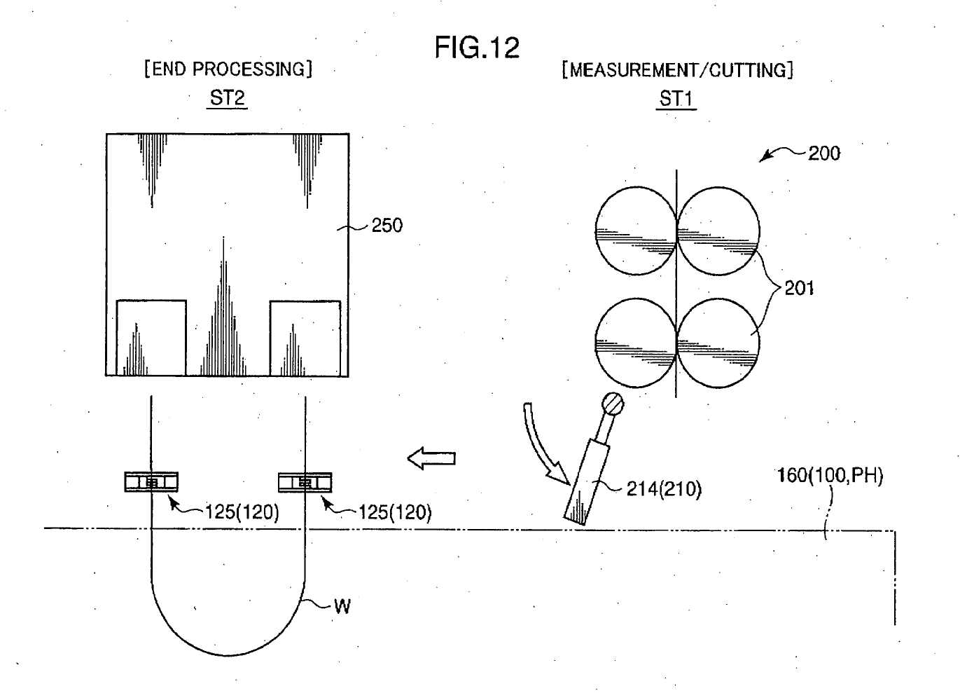

Next, the operation of this embodiment is described with reference to FIGS. 1 to 18.

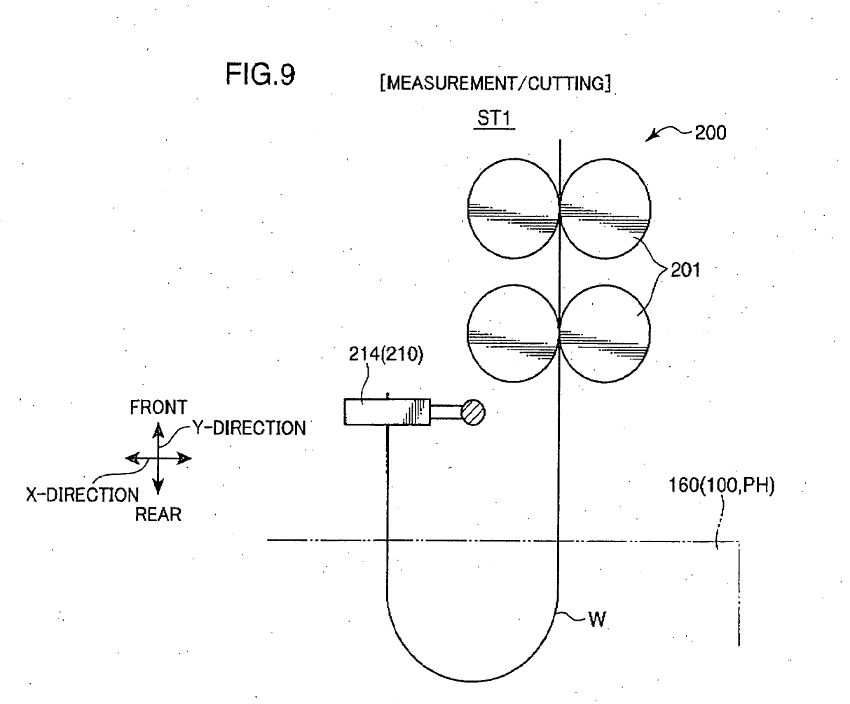

FIGS. 9 to 18 are schematic plan views showing operations of this embodiment.

First with reference to FIGS. 1, 6 and 9, in the process of measuring and cutting the wire W, the wire W is dispensed from the wire measuring/cutting apparatus 200 of the wire measuring/cutting station ST1 while having the dispensed length thereof measured, the dispensed end is clamped by the wire clamp 214 of the wire dispensing apparatus 210, and this wire clamp 214 is turned by 180° to form a loop Of the wire W. On the other hand, as shown in FIGS. 2, 10 and 11, after being moved to the opposite sides of the dispensed looped wire W in their wire releasing positions, the respective wire clamping units 120 of the wire conveyor 100 are displaced to their wire clamping positions when the wire W is measured to a specified length, whereby the corresponding portions of the measured wire W are clamped by the wire clamps 125.

After the wire W is clamped by both wire clamping units 120, the wire dispensing apparatus 210 opens the wire clamp 214 and returns it to a position where it receives the wire W from the wire measuring/cutting apparatus 200, whereas the wire measuring/cutting apparatus 200 drives the cutting unit 203 to cut the wire W.

With reference to FIGS. 4, 5 and 12, the wire clamping units 120 are moved to the end processing station ST2 when the coating wire W is cut. When the respective wire clamping units 120 arrive at positions where they face the stripping unit 250 of the end processing station ST2, the actuators 126 thereof are actuated to advance the wire clamps 125. By doing so, the end portions of the wire W clamped by the wire clamps 125 are fed to the stripping unit 150 to have the insulation coating stripped.

With reference to FIGS. 2 to 5 and 13, after the stripping is completed and the stripped wire ends are inspected, one of the respective wire clamping units 120 located at a more downstream side with respect to the X-direction causes the rod 128a of the air cylinder 128 to extend, thereby pivoting the pivotal member 141 of the pivoting unit 140 to turn the wire clamp 125 by 45° in clockwise direction in FIG. 13.

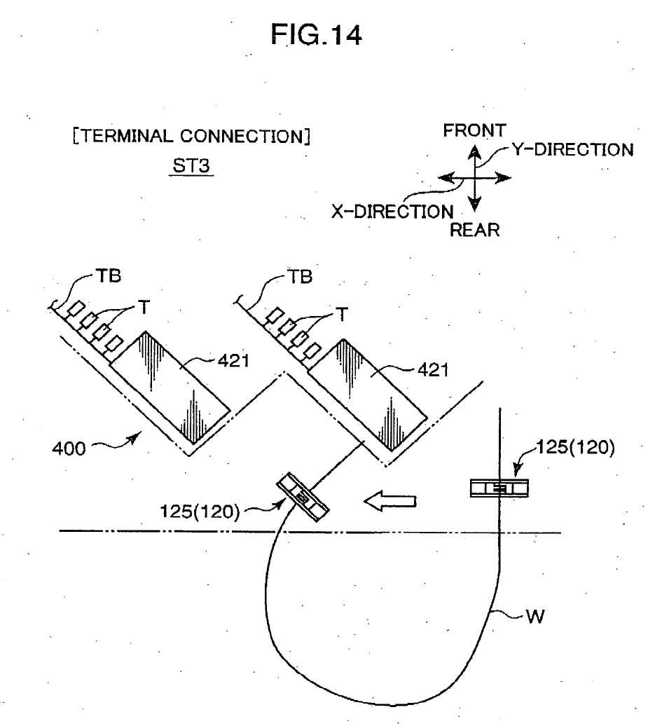

With reference to FIG. 14, simultaneously with the pivoting movement of the wire clamp 125, both wire clamping units 120 are moved to the terminal connecting station ST3 located at the downstream side, where the turned wire clamp 125 is caused to face the applicator 421 corresponding to the end of the wire W clamped by this wire clamp 125 and the wire clamping unit 120 at the upstream side is caused to wait on standby.

With reference to FIGS. 2 to 5 and 15, when the downstream wire clamp 125 is positioned with respect to the X-direction, the servo motor 126a of the one-axis robot 126 is then driven to move the wire clamp 125 forward. Thereby, the end portion of the wire W clamped by this wire clamp 125 is fed into the applicator 421, enabling a terminal T to be crimped into connection therewith. Subsequently, the applicator 421 is driven to connect the terminal T with the end of the wire W similar to a known construction. As described above, since the wire clamps 125 of this embodiment are made resiliently movable upward and downward by the coil springs 148, the end of the wire W can be resiliently moved upward and downward to follow a terminal connecting process upon receiving a driving force of the applicator via the clamp arms 125b in the crimping process by the applicator 421.

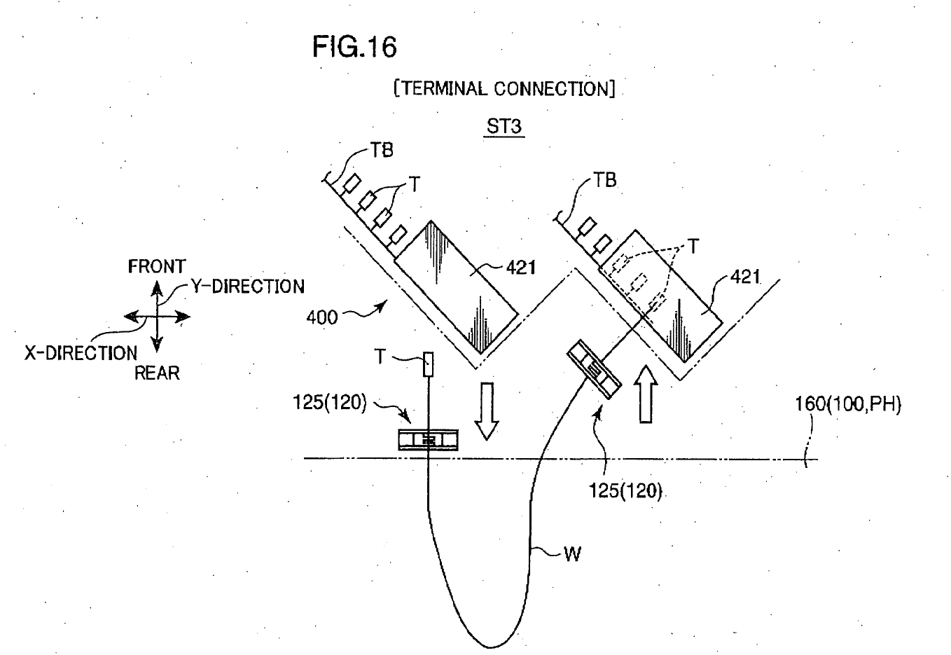

With reference to FIG. 16, when the terminal T is connected with the end of the wire clamped by the downstream wire clamp 125, this downstream wire clamp 125 is moved backward, turned in reverse direction to return to the initial position, and halts until a terminal is crimped into connection with the end of the wire W clamped by the upstream wire clamp 125. On the other hand, the upstream wire clamp 125 feeds the end of the wire W to the corresponding applicator 421 in the same manner as the downstream wire clamp 125 did. In this way, the terminals T are connected with both ends of the wire W.

With reference to FIG. 17, the end portions of the wire W having the terminals T connected therewith are inspected by the inspecting apparatus 450 installed at the inspection station ST4.

With reference to FIG. 18, the inspected wire W is conveyed to the transferring station ST5, where the transferring unit 500 can receive the end portions of the wire W from the wire clamps 125 and transfer them to an unillustrated terminal inserting apparatus. Upon an occurrence of a failure in the above operation processes, a defective product is discarded by temporarily stopping the production line or at the transferring station ST5, lest the defective product should be conveyed to a further operation process at the downstream side.

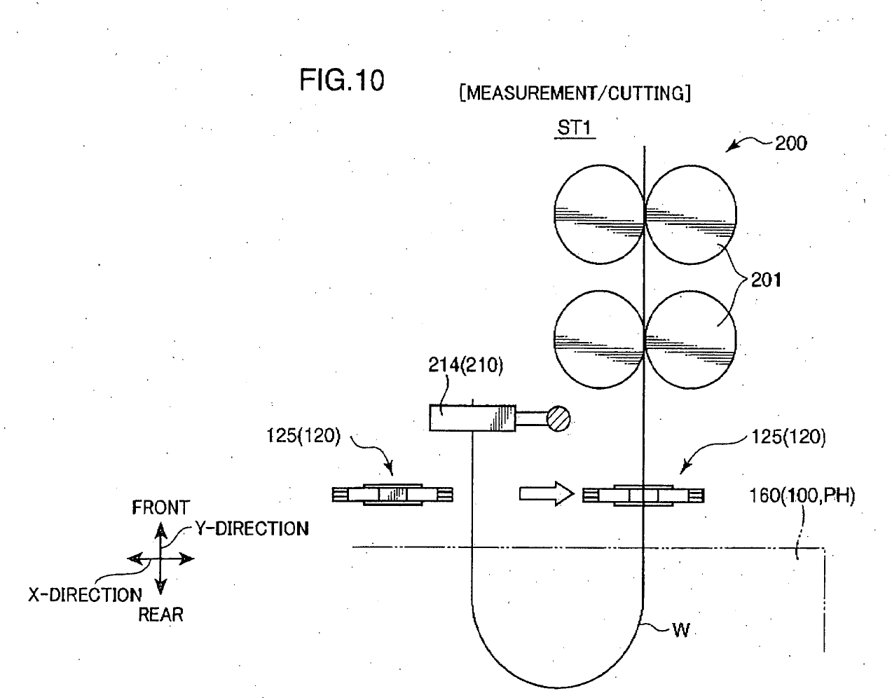

The wire clamping units 120 having transferred the wire W through the above operation processes are returned to the state of FIG. 10 along the wire conveyance path PH while being held in their wire releasing positions and repeat the aforementioned operations while clamping the next wire W.

As described above, according to this embodiment, the ends of the measured wire W cut to a specified measured length can be clamped by the pair of wire clamps 125 in normal state and subjected to a desired processing by sequentially driving the respective wire clamps 125 along the wire conveyance path PH similar to the known construction. Upon crimping the terminal T into connection with the end of the wire W, the positions of the wire clamps 125 are individually switched by the air cylinders 128 and the pivoting units 140 as a switching means, thereby feeding the end of the wire W to the applicator 421 of the terminal crimping apparatus 400 to enable the connection of the terminal T. After the connection of the terminal T, the respective wire clamps 125 are returned to their normal positions, thereby enabling the ends of the wire W to be handled (e.g. fed to the inspecting apparatus 450 to inspection the crimped terminal T or transferred to another apparatus) between the remaining apparatuses (apparatuses other than the terminal crimping apparatuses out of those installed at the stations ST1 to ST5). In this embodiment, since the applicators 421 of the terminal crimping apparatuses 400 are so arranged as to be able to supply the terminal belt TB in the direction oblique to the wire conveyance path PH, the intervals between the respective applicators 420 along the wire conveyance path PH can be maximally narrowed. Thus, this embodiment has a remarkable effect of shortening movement paths of an operator between the respective applicators to improve operation efficiency. Further, since the terminal belt TB can be fed in a straight state, they can be more securely fed, making it unlikely for the applicators 421 to experience a maloperation.

The aforementioned embodiment is merely a preferable specific example of the present invention, and the present invention is not limited thereto.

For example, the applicator used in the terminal crimping apparatus may be of the end feed type that feeds a terminals in which terminals are connected in series, in addition to being of the side feed type that feeds the terminal belt TB in which the terminals T are connected in parallel as in the foregoing embodiment.

Further, it does not matter whether the wire clamps 125 are oblique in clockwise direction or in counterclockwise direction in plan view according to the present invention. In either case, it is preferable that the angle is set at 45°.

According to the present invention, the ends of the measured wire cut to a specified measured-length can be clamped by a pair of wire clamps in normal state and subjected to a desired processing by sequentially driving the respective wire clamps along the wire conveyance path similar to the known construction. Upon crimping the terminal into connection with the wire, the positions of the wire clamps can be individually switched by the switching means and the ends of the wires are, fed to the applicators of the terminal crimping apparatuses to enable the connection of the terminals. After the connection of the terminals, the respective wire clamps are returned to their normal positions, thereby enabling the ends of the wire to be handled (e.g. fed to the inspecting apparatus to inspection the crimped terminals or transferred to another apparatus) between the remaining apparatuses. In the present invention, since the applicators of the terminal crimping apparatuses are so arranged as to be able to feed the terminals in the direction oblique to the wire conveyance path, the intervals between the respective applicators along the wire conveyance path can be maximally narrowed. Thus, there is displayed a remarkable effect of shortening movement paths of an operator between the respective applicators to improve an operation efficiency. Further, since the terminals can be fed in a straight state, they can be more securely fed, making it unlikely for the applicators to experience a maloperation.

This application is based on patent application No. 2003-106938 filed in Japan, the contents of which are hereby incorporated by references. As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to be embraced by the claims.

What is claimed is:

1. An automated production system for wiring harness, comprising:
a wire measuring/cutting apparatus which cuts a wire to a specified measured length,
a pair of wire clamps which clamps near ends of the wire cut at the measured length,
a conveying apparatus which sequentially respectively drives the wire clamps, which holds the clamped wire let to suspend, along a straight wire conveyance path,
a terminal crimping apparatus including a pressing machine arranged along the wire conveyance path, an applicator driven by the pressing machine, and a terminal reel which feeds terminal belt to the applicator, and adapted to crimp a terminal into connection with at least one end of the wire conveyed by the wire clamps, wherein the terminal reel and the applicator are arranged obliquely so that the terminals are fed in a direction oblique to the wire conveyance path, and
a switching unit which individually switches the positions of the respective wire clamps between a pressing position in which the end of the wire can be fed to the applicator to be connected with the terminal and a normal position in which the end of the wire is transferred to and from the remaining apparatuses.

2. An automated production system for wiring harness according to claim 1, wherein sets of the terminal reels and the applicators are arranged in zigzag manner.

3. An automated production system for wiring harness according to claim 1, wherein the conveying apparatus includes a table which individually drives the respective wire clamps along the wire conveyance path.

4. An automated production system for wiring harness according to claim 1, wherein sets of terminal reels and a pair of applicators are arranged in an offset manner and the conveying apparatus includes a table which individually drives the respective wire clamps along the wire conveyance path so that the wire ends are individually fed to the respective applicators.

5. An automated production system for wiring harness according to claim 1, wherein the switching unit includes:
a table conveyed by the conveying apparatus,
a block fixed to the table,
a pivotal member mounted on the block and pivotal about a vertical axis,
a defining member which defines a pivoting range of the pivotal member, and
an actuator which drives the wire clamp fixed to the pivotal member by pivoting the pivotal member within the pivoting range permitted by the defining member.

6. An automated production system for wiring harness according to claim 5, wherein the defining member includes an adjusting member which adjusts the pivoting range.

7. An automated production system for wiring harness according to claim 5, further comprising;
an actuator, provided between the pivotal member and the wire clamp, which drives the wire clamp upward and downward relative to the pivotal member.

8. An automated production system for wiring harness according to claim 1, further comprising:
a wire measuring/cutting station where the wire is dispensed from a roll and cut to the specified measured length,
an end processing station where the ends of the wire cut to the specified measured length are processed,
a terminal connecting station where the terminal Is connected with at least one processed end of the wire by the terminal crimping apparatus.
an inspection station where an inspection of the connected terminal is conducted, and
a transferring station where the terminal of the wire having passed the inspection is transferred.

9. An automated production system for wiring harness according to claim 8, wherein the conveying apparatus reciprocally drives the pair of wire clamps to convey the wire from the wire measaring/outting station to the transferring station and return the same path after a transfer at the transferring station.

10. An automated production system for wiring harness according to claim 8, wherein sets of the terminal reels and the applicators are arranged in zigzag manner.

11. An automated production system for wiring harness according to claim 8, wherein the conveying apparatus includes a table which individually drives the respective wire clamps along the wire conveyance path.

12. An automated production system for wiring harness according to claim 8, wherein sets of terminal reels and a pair of applicators are arranged in an offset manner and the conveying apparatus includes a table which individually drives the respective wire clamps along the wire conveyance path so that the wire ends are individually fed to the respective applicators.

13. An automated production system for wiring harness according to claim 8, wherein the switching unit includes:
a table conveyed by the conveying apparatus,
a block fixed to the table,
a pivotal member mounted on the block and pivotal about a vertical axis,
a defining member which defines a pivoting range of the pivotal member, and
an actuator which drives the wire clamp fixed to the pivotal member by pivoting the pivotal member within the pivoting range permitted by the defining member.

14. An automated production system for wiring harness according to claim 13, wherein the defining member includes an adjusting member which adjusts the pivoting range.

15. An automated production system for wiring harness according to claim 13, further comprising:
an actuator, provided between the pivotal member and the wire clamp, which drives the wire clamp upward and downward relative to the pivotal member.

16. A terminal crimping apparatus usable in an automated production system for wiring harness comprising a wire measuring/cutting apparatus which cuts a wire to a specified measured length, a pair of wire clamps which clamps near the ends of the wire cut at the measured length, and a conveying apparatus which sequentially and respectively drives the wire clamps, which holds the clamped wire let to suspend, along a straight wire conveyance path, comprising;
a main body facing an intermediate portion of the wire conveyance path,
an applicator, provided with the main body, which crimps a terminal into connection with at least one end of the conveyed wire,
a pressing machine, provided with the main body, which drives the applicator, and
a terminal reel which feeds terminal belt to the applicator,
wherein the terminal reel and the applicator are arranged in such positions that the terminals are fed in a direction oblique to the wire conveyance path.

17. A terminal crimping apparatus according to claim 16, wherein the terminal reel and the applicator are assembled into one unit.
